(19) United States
(12) Patent Application Publication
(10) Pub. No.: US 2009/0218181 A1
(43) Pub. Date: Sep. 3, 2009

(54) SERVO MOTOR BRAKE DEVICE

(75) Inventors: Junji Koyama, Azumino-shi (JP); Naoki Kanayama, Azumino-shi (JP)

Correspondence Address: BUCHANAN, INGERSOLL & ROONEY PC, POST OFFICE BOX 1404, ALEXANDRIA, VA, 22313-1404, US

(73) Assignee: Harmonic Drive Systems Inc., Shinagawa-ku (JP)

(21) Appl. No.: 12/370,406

(22) Filed: Feb. 12, 2009

(30) Foreign Application Priority Data
Mar. 3, 2008 (JP) 2008-052147

(51) Int. Cl. F16D 55/02

(52) U.S. Cl. 188/72.7

(57) ABSTRACT

A small-sized, lightweight servo motor brake device (1) that has a low operation speed for releasing a brake during normal operation is provided, wherein compression coil springs (7) cause a slide plate (6) to be pressed against a brake disc (4) that is securely connected to a motor shaft (2), and a braking state is formed. When a small-sized motor (12) causes a cam disc (8) to rotate in a direction in which a cam follower (10) rolls up from a trough (9b) of a cam surface (9) to a peak (9a), the slide plate (6) moves against the spring force away from the brake disc (4), and the device switches to a rotation-maintaining state in which the braking force has been released. When the cam disc (8) is caused to rotate further in the same direction, the cam follower (10) drops from the peak (9a) of the cam surface (9) into a next trough (9b), the slide plate (6) is again pushed against the brake disc (4) by the force of the springs, and the device switches to the braking state in which a braking force acts upon the motor shaft (2).

### TECHNICAL FIELD

The present invention relates to a brake device attached to a motor shaft of a servo motor, the brake device being used for switching between a braking state in which a braking force is applied to the motor shaft so as to prevent rotation, and a rotation-maintaining state in which the braking force is released.

### BACKGROUND OF THE INVENTION

Electromagnetic negative-actuation brakes are typically used as brake devices attached to motor shafts of servo motors. In a negative-actuation brake, an electromagnet is used to attract, against a spring force, an armature that is being pushed against a side of the motor shaft by the spring force, thereby releasing the brake and switching the servo motor to a rotation-maintaining state, as disclosed in, e.g., JP-A 2003-254359.

### SUMMARY OF THE INVENTION

Brake devices for switching servo motors between a braking state and a rotation-maintaining state are required to operate at a high speed when power is interrupted in the event of an emergency. However, supplying electricity (releasing the brake) during normal operation is part of the start-up sequence of the device; therefore, high-speed operation is unnecessary and any extra time spent will not be problematic.

With the foregoing points in view, an object of the present invention is to propose a small-sized, lightweight servo motor brake device that has a low operation speed, and is suitable for use in releasing the brake during normal operation.

In order to solve the abovementioned problems, the servo motor brake device of the present invention comprises:

a brake disc secured to a motor shaft of a servo motor;

a slide plate facing the brake disc in a state of being capable of moving in a direction of an axis of the motor shaft, but incapable of rotating around the axis;

a spring member for generating a braking force and urging the slide plate toward the brake disc;

a cam disc facing the slide plate in a state of being incapable of moving in the direction of the axis, but capable of rotating around the axis;

a cam surface formed on an end surface of the cam disc on the slide plate side, and having a jagged profile projecting toward the slide plate at a uniform pitch along a circumferential direction of the end surface;

a cam follower connected to the slide plate and held in a state of continual contact with the cam surface by an urging force from the spring member; and

a drive motor for rotatably driving the cam disc around the axis.

In order to transmit the rotational force of the drive motor to the cam disc, there may be formed on the cam disc an external gear for transmitting the rotational force from the drive motor to the cam disc. For example, a spur gear may be used for the cam disc.

When the cam follower rolls up a peak of the cam surface in a case where the brake disc is disposed between the cam disc and the slide plate, the slide plate is moved by the cam follower away from the brake disc against the urging force of the spring member, and the braking force on the motor shaft is released.

In the servo motor brake device of the present invention, a mechanical cam mechanism is used to release the braking force acting on the motor shaft of the servo motor, and switch the servo motor to a rotation-maintaining state. An advantage is accordingly presented in terms of making the device smaller in size and lighter in weight than when an electromagnetic brake device is used. Moreover, the drive motor for rotatably driving the disc may be a low-output, small-sized motor; therefore, less power can be consumed than with an electromagnetic brake device.

### BRIEF DESCRIPTION OF THE DRAWINGS

FIG. 1 is a diagram showing a main part of a servo motor brake device to which the present invention is applied; and

FIG. 2 is a diagram showing a portion of a cam disc of the brake device shown in FIG. 1.

### DESCRIPTION OF THE PREFERRED EMBODIMENTS

Embodiments of a servo motor brake device to which the present invention is applied will now be described with reference to the drawings.

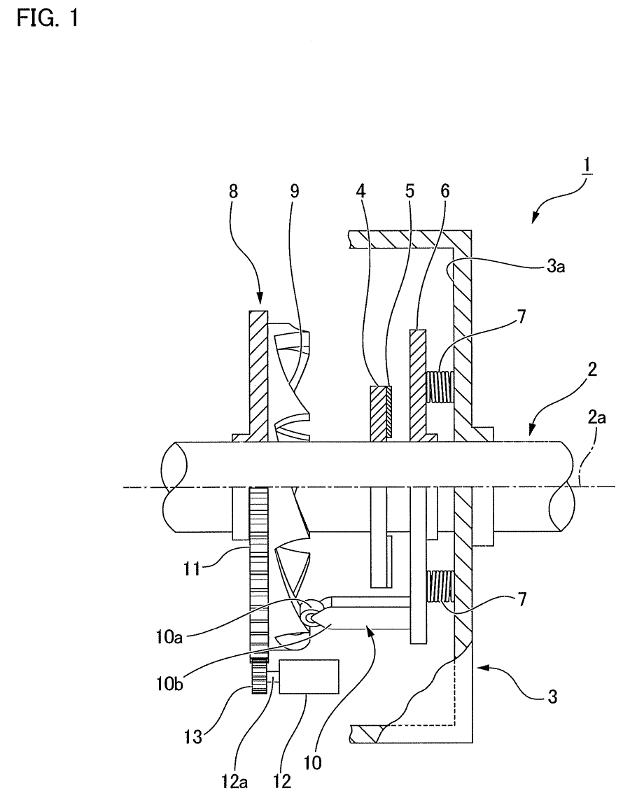

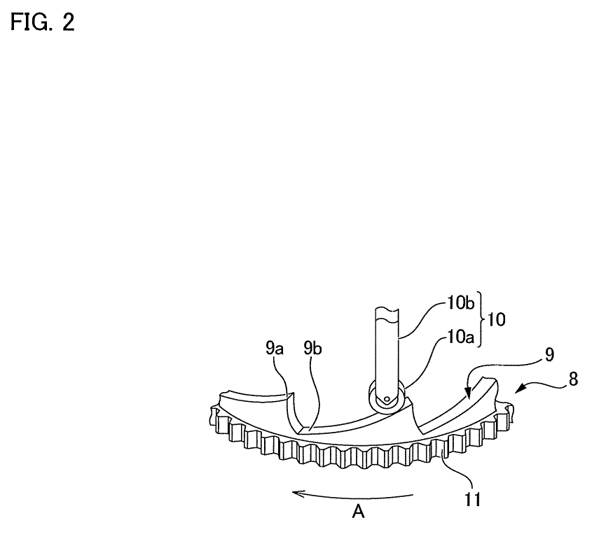

FIG. 1 is a diagram showing a main part of a servo motor brake device according to the present embodiment. FIG. 2 is a diagram showing a portion of a cam disc of the brake device. A servo motor brake device 1 comprises a cylindrical housing 3 through which a motor shaft 2 of the servo motor rotatably passes in a coaxial state. A brake disc 4 is secured to a region of the motor shaft 2 that is positioned inside the housing 3, so that the brake disc 4 integrally rotates in a coaxial state with the motor shaft 2. An annular friction pad 5 of uniform thickness is secured to one end surface of the brake disc 4.

A disc-shaped slide plate 6 faces the friction pad 5 in a coaxial state in the direction of an axis 2a of the motor shaft 2. The slide plate 6 can slide along the motor shaft 2 in the direction of the axis 2a, but is attached to the housing 3 in a state of being unable to rotate around the axis 2a. Compression coil springs 7 for generating braking force are installed in a compressed state between the slide plate 6 and an end surface 3a of the housing 3; e.g., a plurality of compression coil springs 7 are installed at equiangular intervals. The slide plate 6, in a state of being able to slide unobstructed in the direction of the axis 2a, is pushed by the spring force of the compression coil springs 7 against the brake disc 4, with the friction pad 5 disposed therebetween. The slide plate 6 is thereby held in a braking state in which a braking force acts upon the motor shaft 2 to which the brake disc 4 is secured.

A cam disc 8 is disposed coaxially along the direction of the axis 2a of the motor shaft 2 in a region opposite to the slide plate 6, with the brake disc 4 positioned therebetween. The cam disc 8 is unable to move in the direction of the axis 2a, but is supported by the housing 3 in a state of being able to rotate around the axis 2a. On an end surface of the cam disc 8 on the side plate 6 side is formed a cam surface 9, which has a jagged profile in the form of, e.g., saw teeth or ratchet teeth set at a uniform pitch in a circumferential direction along an outside peripheral edge portion of the end surface.

A cam follower 10 is in contact with the cam surface 9 along the direction of the axis 2. The cam follower 10 comprises a roller 10a that is in contact with the cam surface 9 in a rollable state, and a support arm 10b that supports the roller 10a in a rotatable state. The support arm 10b extends parallel to the axis 2a, and is securely connected to an end surface of the slide plate 6 while passing by laterally with respect to an outside periphery of the brake disc 4.

In a state wherein the cam follower 10 has rolled up a peak 9a of the cam surface 9, a state will be assumed wherein the slide plate 6 will be pushed in a direction away from the brake disc 4 along the direction of the axis 2a, and will be separated from the brake disc 4. This state is a rotation-maintaining state wherein the braking force has been released. In contrast, in a state wherein the cam follower 10 has dropped into a trough 9b of the cam surface 9, a braking state will be assumed, wherein the slide plate 6 will be pushed against the brake disc 4 by the spring force of the compression coil springs 7.

An external gear 11 comprising, e.g., a spur gear, is integrally formed with the cam disc 8. The external gear 11 is engaged with a pinion 13 attached to an output shaft 12a of a small-sized motor 12 positioned on an outside periphery of the gear 11. Therefore, when the small-sized motor 12 is driven and the cam disc 8 is caused to rotate in the direction of arrow A, the position of the slide plate 6 along the direction of the axis 2a can be changed according to the rotational angular position of the cam disc 8, whereby it is possible to switch between the braking state in which a braking force acts upon the motor shaft 2, and the rotation-maintaining state in which the braking force has been released.

Specifically, when the small-sized motor 12 causes the cam disc 8 to rotate in the direction in which the cam follower 10 rolls up from the trough 9b of the cam surface 9 to the peak 9a (arrow A), the slide plate 6 moves against the spring force away from the brake disc 4, and the device switches to the rotation-maintaining state in which the braking force has been released. When the cam disc 8 is caused to rotate further in the same direction, the cam follower 10 drops from the peak 9a of the cam surface 9 into a next trough 9b, the slide plate 6 is again pushed against the brake disc 4 by the force of the springs, and the device switches to the braking state in which a braking force acts upon the motor shaft 2.

1. A servo motor brake device comprising:
a brake disc secured to a motor shaft of a servo motor;
a slide plate facing the brake disc in a state of being capable of moving in a direction of an axis of the motor shaft, but incapable of rotating around the axis;
a spring member for generating a braking force and urging the slide plate toward the brake disc;
a cam disc facing the slide plate in a state of being incapable of moving in the direction of the axis, but capable of rotating around the axis;
a cam surface formed on an end surface of the cam disc on the slide plate side, and having a jagged profile projecting toward the slide plate at a uniform pitch along a circumferential direction of the end surface;
a cam follower connected to the slide plate and held in a state of continual contact with the cam surface by an urging force from the spring member; and
a drive motor for rotatably driving the cam disc around the axis.

2. The servo motor brake device according to claim 1, wherein an external gear for transmitting rotational force from the drive motor to the cam disc is formed on the cam disc.

3. The servo motor brake device according to claim 1, wherein:
the brake disc is disposed between the cam disc and the slide plate; and
when the cam follower rolls up a peak of the cam surface, the slide plate is moved by the cam follower away from the brake disc against the urging force of the spring member, and the braking force on the motor shaft is released.

4. The servo motor brake device according to claim 2, wherein:
the brake disc is disposed between the cam disc and the slide plate; and
when the cam follower rolls up a peak of the cam surface, the slide plate is moved by the cam follower away from the brake disc against the urging force of the spring member, and the braking force on the motor shaft is released.
